(19) United States
(12) Patent Application Publication
(10) Pub. No.: US 2013/0147297 A1
(43) Pub. Date: Jun. 13, 2013

(54) Magnetic Motor Propulsion System

(71) Applicant: Harold Elmore, Caddo Gap, AR (US)

(72) Inventor: Harold Elmore, Caddo Gap, AR (US)

(21) Appl. No.: 13/314,827

(22) Filed: Dec. 8, 2011

(51) Int. Cl. H02K 21/00; H02N 11/00

(52) U.S. Cl. 310/152; 74/DIG. 9

(57) ABSTRACT

A magnetic propulsion system comprising: a cylinder; a first plurality of magnets inserted through the cylinder, where the magnets protrude into the interior of the cylinder; a series of disks aligned through the interior of the cylinder; and a second plurality of magnets extending from the exterior edge of each disk. The first plurality of magnets may protrude into the cylinder at an angle. A shaft extends through each disk in the interior of the cylinder. Each respective pole of the first plurality of magnets equates to each pole of the second plurality of magnets to create the propulsive motion.

### BACKGROUND OF THE INVENTION

1. Field of Invention

The present invention relates to a magnetic propulsion motor that utilizes magnetic components as a power source.

2. Description of Related Art

Magnetic propulsion is a concept that enables the movement of a device based upon the magnetic fields and arrangement of magnets within a system in order to effectively propulse the device. Magnetic propulsion provides an alternative to electrical or petroleum-powered motors therefore some energy saving advantages are related to the use of magnetic propulsion devices. Magnetic propulsion has been demonstrated in the prior art. Many of the systems of the prior art utilize complex devices to effectively utilize the magnetic properties to create the movement. These devices of the prior art therefore are very costly to manufacture and to implement. Many of these systems implement the particular concept of magnetic propulsion, however further development and implementation of more novel and inexpensive devices that may lower costs but also provide effective propulsion systems are necessary.

### SUMMARY OF THE INVENTION

The present invention relates to a magnetic propulsion system comprising: a cylinder; a first plurality of magnets inserted through the cylinder, where the magnets protrude into the interior of the cylinder; a series of disks aligned through the interior of the cylinder; and a second plurality of magnets extending from the exterior edge of each disk. The first plurality of magnets may protrude into the cylinder at an angle. A shaft extends through each disk in the interior of the cylinder. Each respective pole of the first plurality of magnets equates to each pole of the second plurality of magnets to create the propulsive motion.

### BRIEF DESCRIPTION OF DRAWINGS

FIG. 1 shows a sectional view of a magnetic propulson system according to the present invention.

FIG. 2 depicts a disk used in conjunction with the magnetic propulson system in accordance with the present invention.

FIG. 3 depicts a side view depicting the magnetic propulson system according to the present invention.

### DETAILED DESCRIPTION

The present invention relates to a magnetic propulsion system utilized to create a torque effect that rotates a shaft thus creating a magnetic propulsion motor. This magnetic propulsion system according to the present invention utilizes a plurality of magnets placed around the perimeter of a cylinder. A series of disks are provided within the cylinder that also includes a plurality of magnets placed along the outer edge of the disk. The disks with the magnets are inserted in the cylinder where north poles are placed along the interior perimeter of the cylinder. Opposing north poles are positioned on the disks within the cylinder and a shaft may be inserted through the center of the disks that are positioned through the cylinder. This positioning of the magnetic poles and placement of the disks creates a turning effect due to the repulsion of the north poles. The magnets are placed at angles along the perimeter of the cylinder and therefore create a turning motion of the disks.

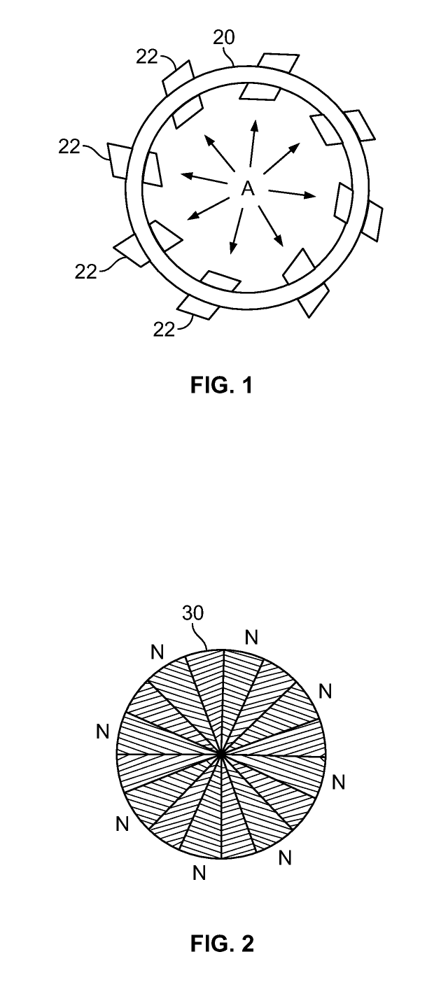

In reference to FIG. 1, a cross-sectional view of a cylinder used in accordance with the magnetic propulson system of the present invention is shown. A Cylinder 20 depicted in FIG. 1 includes a plurality of Magnets 22 along the perimeter of the Cylinder 20. Each magnet is inserted at an angle and protrudes into the interior perimeter of the Cylinder 20. Magnetic fields emit from each of the magnets and in one particular embodiment a north pole is provided on the interior of the Cylinder 20.

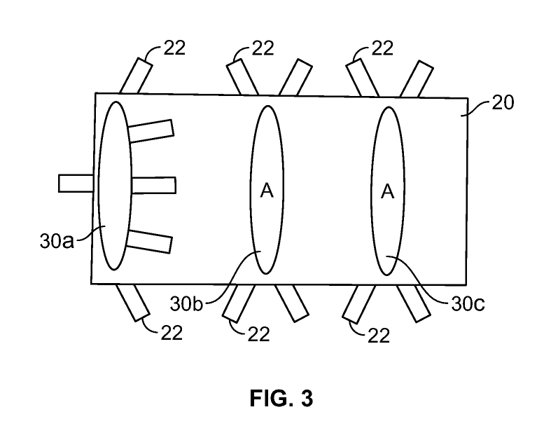

In reference to FIG. 2, a Disk 30 is depicted. The Disk 30 includes a plurality of magnets attached to the rear edge perimeter, as more clearly shown in FIG. 3. The Disk 30 is inserted into the interior of the Cylinder 20 and a shaft may be inserted through the center of the disk in order to create a magnetic motor. The magnets attached to each disk, in one particular embodiment, include a north pole configuration to oppose the north pole configurations of the Magnet 22 inserted in the Cylinder 20. The like magnetisms of the poles repel and then create a circular movement of the disks within the Cylinder 20.

FIG. 3 depicts a view of the insertion of multiple Disks 30a, 30b, 30c within the Cylinder 20. The disks are aligned with the series of Magnets 22 that are inserted through the perimeter of the Cylinder 20. Also shown on Disk 30a are Magnets 32, which are inserted along the perimeter edge of the Disc 30a and repel against a Magnet 22 within the perimeter of the Cylinder 20. A Shaft 40 is also shown extending from the Cylinder 20. This Shaft 40 supplies a means for attachment to capture the rotation provided by the disks within the Cylinder 20.

The Cylinder 20 maybe made of aluminum metals in one particular embodiment and further the Disk 30 may be also made of aluminum. The Magnets 22 as stated above are inserted in an angle to achieve maximum propulsion of the disks rotating within the Cylinder 20. The rotation of the shaft is achieved by the repulsive propulsion created by the magnets within the Cylinder 20 and along each Disk 30. The speed of rotation depends upon strength of the magnets themselves and the ability to effectively continue the movement of the disks within the cylinder once the propulsion is created due to the magnetism of the opposing magnets. The instant invention has been shown and described in what it considers to be the most practical and preferred embodiments. It is recognized, however, that departures may be made there from within the scope of the invention and that obvious modifications will occur to a person skilled in the art.

What is claimed is:

1. A magnetic propulsion system comprising:
a. a cylinder;
b. a first plurality of magnets inserted through the cylinder, where the magnets protrude into the interior of the cylinder;
c. a series of disks aligned through the interior of the cylinder; and
d. a second plurality of magnets extending from the exterior edge of each disk.

2. The magnetic propulsion system according to claim 1, where the first plurality of magnets protrude into the cylinder at an angle.

3. The magnetic propulsion system according to claim 1, further including a shaft through each disk in the interior of the cylinder.

4. The magnetic propulsion system according to claim 1, where each respective pole of the first plurality of magnets equates to each pole of the second plurality of magnets.
